(19) United States
(12) Patent Application Publication
(10) Pub. No.: US 2005/0021784 A1
(43) Pub. Date: Jan. 27, 2005

(54) Device and method for the automatic configuration of user profiles

(76) Inventor: Christian Prehofer, Munchen (DE)

Correspondence Address: BELL, BOYD & LLOYD, LLC, P. O. BOX 1135, CHICAGO, IL, 60690-1135, US

(21) Appl. No.: 10/489,027

(22) PCT Filed: Sep. 2, 2002
(86) PCT No.: PCT/DE02/03224

(30) Foreign Application Priority Data
Sep. 7, 2001 (DE) 101 44 023.5

(51) Int. Cl. G06F 15/16

(52) U.S. Cl. 709/229; 709/203

(57) ABSTRACT

The present invention relates to a central server structure, as a dynamic and personal information base, for the protocol independent and central user management, in particular the authentication and management of personal parameters and preferences in fixed and mobile networks, whereby the central server also undertakes the software management.

### BACKGROUND OF THE INVENTION

The present invention relates to a device for the automatic configuration of user profiles in terminals in a telecommunications and/or data network having a number of application servers, wherein a so-called profile server is used as a central server for the management, storage and updating of the user profiles.

In a network, with many applications a user must first log on to and be authenticated by an application server in order to be able to use the applications following appropriate authorization. During authentication, the user gives his/her identity for recognition, and the application server then determines whether the user has access authorization or not. Authentication is necessary in order to protect the personal data of the user on the network from unauthorized access. Access is granted if the user identifies himself/herself correctly, i.e., if his/her user-specific details match entries in a special user database. In practice, authentication is usually implemented in the form of a prompt for a password. A data record (account) required for authentication usually consists of a unique user identifier (user ID, user name) and a personal, non-transferable item of knowledge (password). The task of so-called user management is to store the data required for identifying application users. The user management should be set up in such a way that it is as central and secure as possible and is open for the services in question. It can be achieved either by a local user database of the application server belonging to the operating system, by a system-independent database, or by an external authentication server (e.g., RADIUS server or POP server). Choice of the aforesaid variants depends on the user group concerned and the range of services to be offered.

However, arrangements are also known in which the authentication of users is performed directly during login to the network by an authentication server in conjunction with a local user database subordinate to the authentication server. This database exists independently (i.e., it can only be updated manually), such as by matching against a central user database, so that every single user profile in the user database of the authentication server must be updated and passwords are not transferred automatically.

In addition to the arrangements described, server systems are also known in which personal user data is updated automatically. An example of this is the server system RADIUS (remote authentication dial in user server), which is explained below with reference to FIG. 1.

FIG. 1 shows a so-called RADIUS server 1 implemented in a network and working in the background. To authenticate a user 2 who has logged on via a telephone network (here PSTN), access can be effected via the RADIUS server 1 to a central password database 3. For this, the relevant password file is read out and sent via the RADIUS server 1 to an authentication server 4. The information held in the password file can be fully utilized in the server 4 for user authentication. It is therefore possible to integrate entire ranges of users in the authentication routine for relatively little outlay. The RADIUS server 1 works here in the background and communicates with the authentication server 4 using a suitable transmission protocol (e.g., UDP/IP). If the authentication server 4 cannot authenticate the user 2 on the basis of its local information stored in a local database 5, it contacts the RADIUS server 1. If the user 2 is present in its database 3, the password prompt is started via the authentication server 4, with a standard transmission protocol (e.g., PAP) having used for this purpose. In addition to the password prompt, the RADIUS server 1 can pass on further information to the authentication server 4, such as the transmission protocol to be used, for example.

With the development of more powerful, mobile networked terminals (e.g., mobile phones, PDAs), it is increasingly common for a user to access applications offered by application servers in a network from different terminals (mobile and stationary). If mobile terminals are used, owing to the usually limited operating facilities (e.g., no standard keyboard) it is important to design both the authentication routine and the use of the applications to be as simple as possible or to adapt them accordingly. However, the login concepts and authentication routines currently available do not usually differentiate between whether the user is equipped with a mobile or stationary terminal.

Besides limited facilities for input, mobile terminals often also have the limitation of a low storage capacity. When an application program offered by an application server is called, a part program usually must first be installed permanently on the terminal. This so-called client part is usually complete the first time the application program is called; i.e., the entire client application in all its variants is downloaded onto the terminal and is installed permanently as a software component. It is often the case however, that when the complete client part is installed, significantly more storage space is occupied on the terminal than would actually be necessary for the simple execution of the application program because, for example, different language versions, color settings, etc. are installed as well. In particular mobile terminals often do not have sufficient storage space available, so that in this case (in some circumstances) certain application programs cannot run, or can run only to a limited extent.

An object of the present invention is, therefore, to simplify for mobile, networked terminals the entire use of application programs as far as possible, including logging on to the required application servers, and to adapt it to the terminal with the associated user.

This technical problem is solved by a device in accordance with the teachings of the present invention. One aspect of the present invention is that a profile server provides as central server a dynamic and user-related information base for user management, particularly for the authentication and management of user-specific settings required by application programs. In addition, the profile server handles the management of so-called cache files, the latter being files that the user accesses as standard. Ultimately, the user transmits only the necessary data for or with the application, programs on to his/her mobile device.

In order to do so, the user profiles are first sent by all application servers available in the network to the profile server. The profile server then offers the service of sending the applications and configuration data suitably adapted for the user onto his/her terminal. Furthermore, via an appropriate synchronization operation, the profile server automatically updates the user profiles sent.

The profile server is moreover designed in such a way that the user identities of a user in different networks can be mapped one another via the server. A user with a particular identifier in the fixed network or the Internet (fixed network telephone number or Internet address) and a mobile device, such as a mobile phone with a particular mobile phone number which serves as a user identity in the mobile network, can thus install the personalized software on the mobile device as soon as the profile server has been sent the user data by the application server.

A particular advantage of the present invention is that the profile server knows the access authorizations of the individual users for access to the application servers in the network and manages the user configuration. The profile server handles the authorization procedure and identifies the user with the associated, stationary terminal on the basis of an identifier sent by the mobile terminal, such as the GSM telephone number, for example. Via the stored user profile, the profile server knows firstly the access authorization and furthermore the user-specific client parts of the different application programs. Only the actually required personalized part of an application is then loaded onto the mobile device of the user via the profile server.

In addition, it is also possible for a user authorization to be handled by an application server itself. Following this, the application server sends to the profile server the user-specific client parts, which are available to the user for a later time on all networks accessible to the profile server.

In a special embodiment of the present invention, the profile server is designed in such a way that, in addition to the aforesaid management of the user profiles, it also handles management of the cache files. This basically constitutes a mirroring of the cache files between the terminal and the profile server, so that the files which the respective user accesses as standard are automatically present both on the profile server and on the terminal. Owing to the synchronization between the profile server, the application servers and the terminals in the network, a change of both the user profile and of the cache files of a user is automatically detected simultaneously or at the latest at log-off, and the previously valid data is updated.

An advantage of this embodiment is that not only the user profiles but also the cache files can be mapped onto one another. Via the profile server, the terminal of a user is automatically supplied with the relevant user-specific data and settings, so that the application programs run on the mobile terminal already adapted to the user profile, and that the frequently used files are available to the user irrespective of the terminal. The latter also serves as a backup for important personal files.

Additional features and advantages of the present invention are described in, and will be apparent from, the following Detailed Description of the Invention and the Figures.

### BRIEF DESCRIPTION OF THE FIGURES

FIG. 1 shows a structural representation of a user authentication procedure with a RADIUS server structure as an example of the prior art.

FIG. 2 shows an embodiment of the present invention in which the profile server handles the management of the personalized software components and those of the user profiles.

FIG. 3 shows a representation of the basic procedure of an authentication and user-specific installation of an application program in an embodiment of the present invention.

FIG. 4 shows a basic design of the profile server in one embodiment of the present invention in which the profile server handles the management of the user profiles, the cache files and the personalized client programs.

FIG. 5 shows an embodiment of the present invention in which the access data for different applications is held on an additional authentication server for security reasons.

### DETAILED DESCRIPTION OF THE INVENTION

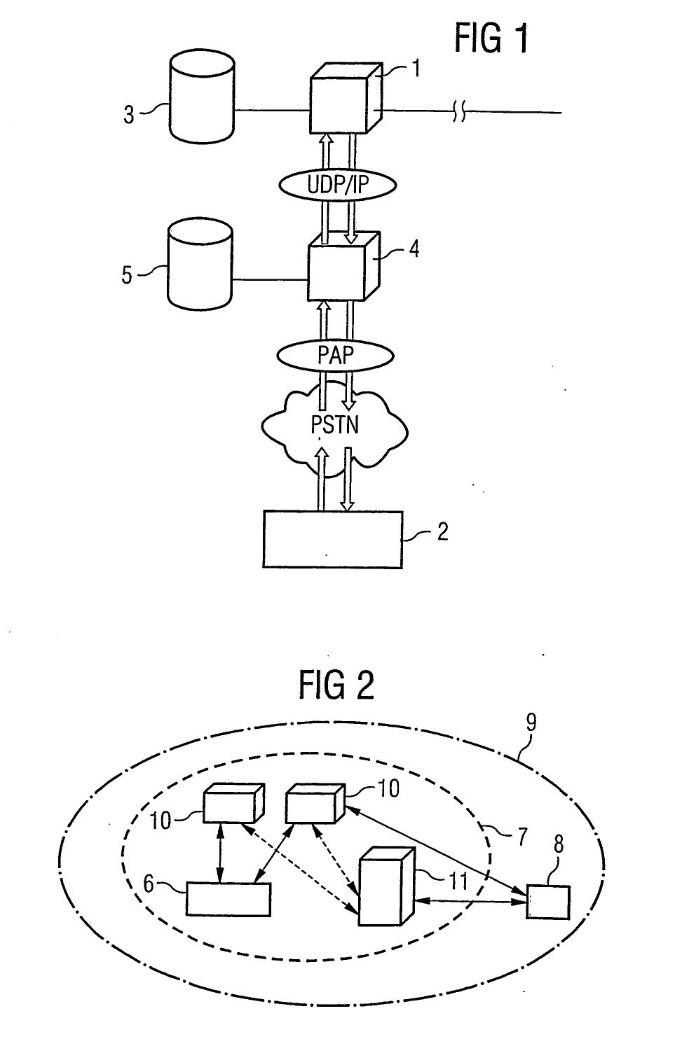

FIG. 1, as already described in the introduction, shows the procedure for a user authentication with a RADIUS server structure I as an example of the prior art. In this case, there is no loading of the corresponding personal user data for or with the respective application programs, specifically for a mobile device 8. The authentication is performed, irrespective of the terminal of the user 2, in accordance with a routine in which an identifier and a password must be entered.

FIG. 2 shows an embodiment of the present invention in which a profile server 11 handles the management of personalized applications and user data for the installation on a mobile device 8. The essential parts shown are a stationary device 6 of a user 2 which is integrated in a network 7, a mobile device 8 of the same user 2 on which the same applications as on the stationary device 6 are used and which is located in a mobile network 9, a number of application servers 10 on which application programs run, wherein many of the programs also require a client part that runs on the terminal 6 and 8, as well as a profile server 11 for managing personalized applications and user data.

Shown in FIG. 2 is a scenario in which a user 2 uses application programs that are made available on the application servers 10 on two terminals, a mobile terminal 8 and a stationary terminal 6. In addition, in both cases the user 2 uses the same identifier and the same user setting for the respective application on an application server 10. If the data is changed on one of the terminals 6 or 8, it should also be changed for the access via the respective other device 8 or 6. With respect to the access authorization, the application servers 10 are configured in such a way that they can manage the user data (name, password, etc.) themselves.

The scenario described above corresponds to a typical configuration such as in an intranet having a number of application servers 10 and a stationary 6 and mobile 8 terminal of an identical user 2.

The concept of the present invention is achieved via the profile server 11. In this case, the different application servers 10 send the user data to the profile server 11, which handles the management of the user profiles and regularly forwards the applications and configuration data suitably adapted to the user 2 to the terminals 6 and 8 of the user 2. In the case of changes to the data of the mobile or stationary terminal 8 or 6, a respective synchronization is performed. The profile server 11 knows the access authorizations of the individual users 2 for access to the application servers 10 in the network 7 and handles the authorization procedure during the login of mobile terminals 8. On the basis of an identifier sent by the mobile terminal 8, such as the GSM telephone number, the profile server 11 identifies the user 2 with the associated, stationary terminal 6. Via the stored user profile, the profile server 11 knows firstly the access authorization and furthermore the user-specific client parts of the different application programs. Only the actually required personalized part of an application is then loaded onto the mobile device 8 of the user 2 via the profile server 11.

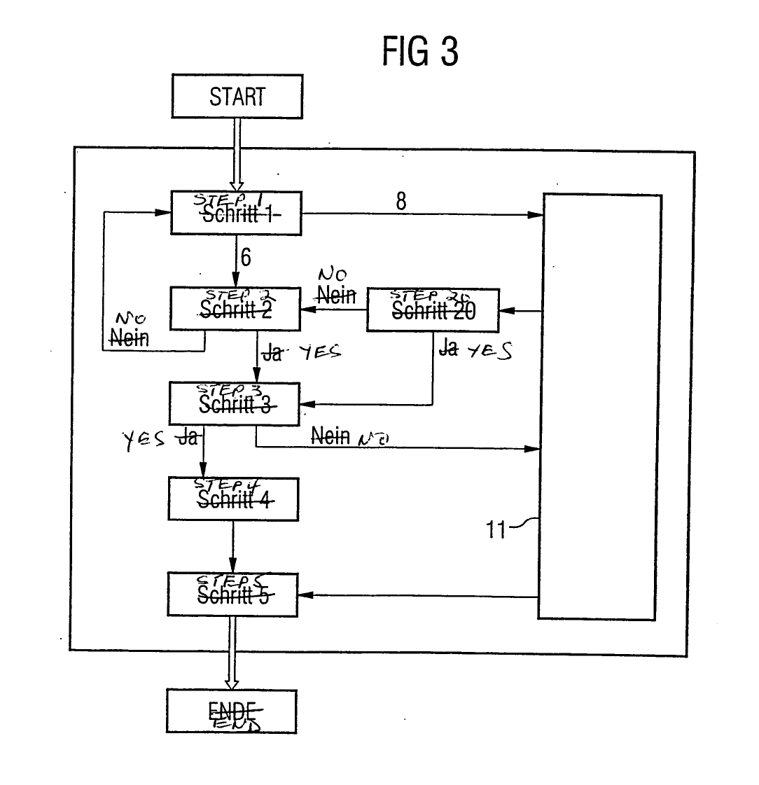

FIG. 3 shows the basic procedure of an authentication and user-specific installation of an application program in an embodiment of the present invention. In the case shown here, a user 2 wishes to access an application program that is present on the application server 10. For this, first of all the type (mobile or stationary) of the terminal of the user 2 is established (step 1); in the case of a stationary terminal 6 the authentication of the user 2 proceeds through the standard routine described in the introduction with prompting for an account, etc., which takes place in step 2. If, however, a mobile terminal 8 is present, then the authentication procedure of the user 2 will refer to the profile server 11, and the latter then handles, via the GSM telephone number, the authentication adapted for a mobile terminal 8 (step 20). If the user 2 of the mobile terminal 8 is authorized; (i.e., if the inputs of the user 2 match the information available to the profile server 11), the procedure moves on to step 3. In step 3 it is checked whether the user 2 is using the application for the first time, or whether it is already possible to re-use a personalized program. In the latter case, the user 2 is referred again to the profile server 11, which then assigns to the user 2 the user-specifically customized part program of the client application, which part program is loaded onto the terminal 6 or 8 and is then available to the user 2. If the application is being used for the first time, it is first of all necessary for a complete client application of the application to be installed on the terminal 6 or 8 (step 4). Following this, the user 2 can personalize the client application, such as by selecting the language or the color setting, and subsequently start it. What remains of the client part of the application on the terminal is the user-specifically customized part program of the client application which is transmitted to the profile server 11 at the next synchronization and is available there for subsequent installations of the application program.

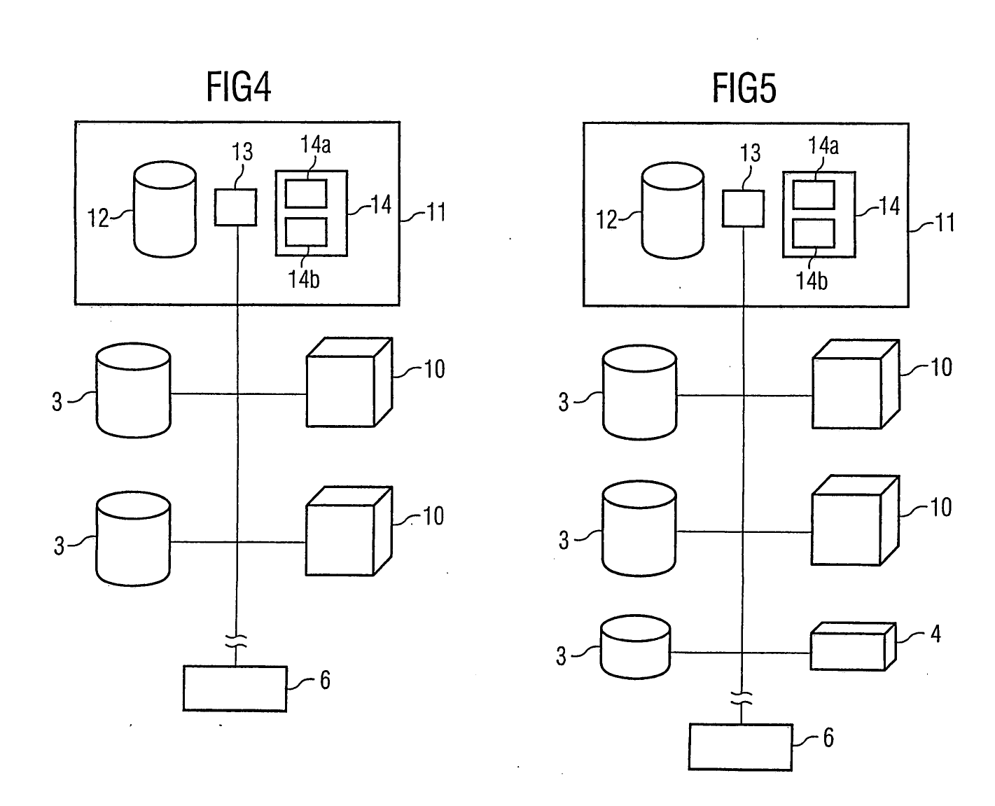

FIG. 4 shows a basic structure of the profile server 11 in one embodiment of the present invention in which the profile server 11 handles the management of the user profiles, the cache files and the personalized client programs. The profile server 11 consists of a profile database 12 for storing updated user data, user configurations, personalized software components and cache files, as well as a profile management unit 13 for the management of user profiles and of personalized software components and for the management of cache files, and furthermore of an updating unit 14 having a synchronization unit 14a for synchronizing the profile server 11 with the application servers 10 and a duplication unit 14b for mirroring the user profiles of all users 2 of the application servers 10 and for mirroring the cache files of all users 2 of the associated terminals 6 or 8 on the profile server 11.

An updating of the user profiles stored in the profile database 12 is performed at regular intervals via the updating unit 14. For this purpose, the current profiles of the users 2 are interrogated by the individual application servers 10 and are compared with the previously valid profiles stored in the profile database 12 in the profile management unit 13. The comparison operation is conducted in such a way that ultimately the current data is stored in the profile database 12 in each case. During this procedure, a distinction is drawn between whether it concerns user-specific data (e.g., identifier, password, etc.), personalized software components (e.g., particular language version, color setting, etc.), or cache files.

With the embodiment of the present invention illustrated in FIG. 4, it is possible via a conventional authentication for a user 2 to log on to the different application servers 10 with a stationary terminal 6. The applications offered can thus be used on the stationary device 6. During the further procedure, first of all the user profile (i.e., the account required for the individual application servers 10), and furthermore the user-specifically customized programs of the client parts of the applications are sent to the profile server 11. In each case, up-to-date user profiles and software components are stored in the profile database 12 of the profile server 11. In addition, the profile server 11 mirrors the cache files of the user 2 from the terminal 6 and creates a copy of the cache files in the profile database 12. The whole system is now configured so that the user 2 can log on with a mobile terminal 8 via the profile server 11. The profile server 11 must here assign to the user 2 of the mobile terminal 8 (e.g., via a GSM telephone number) the access authorization of the user 2 with the stationary device 6. In the next step, the profile server 11 then installs the personalized software components of the client part of the applications as well as the cache files on the mobile terminal 8, so that the user 2 can use the different applications of the application servers 10 directly from the mobile terminal 8 without going through a conventional authentication routine.

FIG. 5 shows an embodiment of the present invention in which the access data for different applications is held on an additional authentication server for security reasons. In this embodiment, the present invention functions analogously to the procedure illustrated in FIG. 4, the application servers 10 interrogating in each case the authentication server 4 during login of the user 2, and the profile server 11 obtaining the data from the authentication server analogously.

Although the present invention has been described with reference to specific embodiments, those of skill in the art will recognize that changes may be made thereto without departing from the spirit and scope of the present invention as set forth in the hereafter appended claims.

1. A device for the automatic configuration of user profiles on terminals (6, 8) in a telecommunications and/or data network having a plurality of application servers (10), characterized by a profile server (11) for the management, storage and updating of the user profiles.

2. The device as claimed in claim 1, characterized in that the profile server (11) has a synchronization unit (14a) for synchronization between the profile server (11) and the plurality of application servers (10).

3. The device as claimed in claim 1 or 2, characterized in that that profile server (11) contains a duplication unit (14b) for mirroring the user profiles of all users (2) of the application servers (10) and/or of cache files of all users (2) of the terminals (6 and/or 8) on the profile server (11).

4. The device as claimed in one of claims 1 to 3, characterized in that the profile server (11) maps user identities of a user (2) in different networks onto one another, in particular for the purpose of synchronization or duplication.

5. The device as claimed in one of claims 1 to 4, characterized in that the profile server (11) has a profile management unit (13) for managing user profiles, for storing current user data and user-customized program parts and/or for updating the cache files of the users (2).

6. The device as claimed in one of claims 1 to 5, characterized in that the profile server (11) receives user profiles of the users (10) and/or access data for different applications of the application server (10) from a special authentication server (4) and manages said profiles.

7. A method for the automatic configuration of user profiles on terminals (6, 8), having the steps:
(a) transfer of a user profile of a user (2) on a terminal (6, 8) to a profile server (11) by an application server (10),
(b) installation of the user-specific components of application programs on the terminal (6, 8) of the user (2) by the profile server (11).

8. The method as claimed in claim 7, characterized in that prior to step (b) of the installation of the user-specific components of application programs on the terminal (6, 8), the profile server (11) maps user identities of the user (2) in different networks onto one another.

9. The method as claimed in claim 7 or 8, characterized in that the step (a) of the transfer of the user profile to the profile server includes in particular a mirroring of cache files of the user (10) used as standard from the terminals (6, 8) of the user (2) on the profile server (11).

10. The method as claimed in one of claims 7 to 9, characterized in that the step (b) of the installation of the user-specific software components includes in particular a transfer of cache files of the user (10) used as standard from the profile server (11) onto the terminal (6, 8) of the user (2).

11. The method as claimed in one of claims 7 to 10, characterized in that the step (a) of the transfer of the user profile includes in particular a transfer to the profile server (11) of the access data of the user (10) originating from a special authentication server (15) for the application programs of the application servers (10).

12. The method as claimed in one of claims 7 to 11, characterized in that authentication of a user (2) is performed by means of an application server (10).
